(19) United States
(12) Patent Application Publication
(10) Pub. No.: US 2006/0233371 A1
(43) Pub. Date: Oct. 19, 2006

(54) Roaming encryption key rekeying apparatus and method

(76) Inventors: Hans C. Sowa, Schaumburg, IL (US); Michael W. Bright, Arlington Heights, IL (US); Chris A. Kruegel, Plainfield, IL (US); Thomas J. Senese, Schaumburg, IL (US); Timothy G. Woodward, Tempe, AZ (US)

Correspondence Address: MOTOROLA, INC., 1303 EAST ALGONQUIN ROAD, IL01/3RD, SCHAUMBURG, IL, 60196, US

(21) Appl. No.: 11/396,722

(22) Filed: Apr. 3, 2006

Related U.S. Application Data
(60) Provisional application No. 60/671,197, filed on Apr. 14, 2005.

(51) Int. Cl. H04K 1/00

(52) U.S. Cl. 380/248

(57) ABSTRACT

Roaming encryption key rekeying apparatus and method comprising a first system key management facility that communicates to a communication unit roaming information is disclosed. The roaming information is encrypted using a first encryption scheme that is decipherable by the communication unit. Further, the first system key management facility communicates to a second system key management facility the roaming information. In this communication, the roaming information is encrypted as a function of a second encryption scheme that is decipherable by the second system key management facility.

### TECHNICAL FIELD

This invention relates generally to encrypted communications and more particularly to wireless over-the-air rekeying.

### BACKGROUND

Encryption methodologies of various kinds are well known in the art. In general, the contents of a so-called plain-text message (which may comprise, for example, an alphanumeric message, digitized voice or vocoded voice, and so forth) are encoded pursuant to an encryption algorithm as a function of one or more encryption keys. Ideally, the resultant data stream will appear, for all intents and purposes, as a random string of data elements (such as alphabetic characters or binary ones and zeros) notwithstanding the underlying pattern of the original informational content itself. Encryption techniques are often employed to protect wireless communications from unauthorized monitoring and eavesdropping.

Maintaining the security of an encrypted communication system usually requires ongoing care and careful observation of specific procedures. For example, the encryption key(s) itself must be well protected as the encryption algorithm utilized by a given system will itself often be known or ascertainable. System operators prefer to arrange for encryption keys to be provided to the communication units of a given system on an as-needed basis (or shortly before such anticipated need). When a system operator has direct physical access to a given communication unit, encryption key(s) can be installed with a relatively high assurance of security as the operator can chose a physical location and the circumstances attending such installation.

It is not always convenient or even possible, however, for all of the wireless communication units in a given system to be brought, more or less simultaneously, to a common location to permit the physical installation of a new encryption key. As a result, the logistic challenge of installing a new encryption key over a wide number of geographically distributed communication units can be challenging enough to discourage some operators from varying their encryption keys in a sufficiently aggressive manner to comport with generally recommended security protocols.

One solution has been to provide a wireless transmission informing the communication units of the encryption key(s). To protect the encryption key(s), a rekeying message, including the encryption key(s), is often encrypted through use of another encryption key. In a relatively closed system, this approach tends to constitute a satisfactory solution. A key management facility of a wireless communication system can readily accommodate the necessary process to effect the installation of encryption keys in the communication units while maintaining a level of security. For example, the key management facility sends rekeying messages to communication units to communicate encryption keys.

However, when the communication unit has moved to another system where the encryption keys are different, communication of encryption keys is a problem. To meet this need, the prior art provides for a communication link between key management facilities of differing systems so that encryption keys can be communicated. For example, a key management system of the first system will provide the encryption keys for communicating with a specific communication unit to a key management facility of a second system. Once the key management facility of the second system knows of the encryptions keys for communicating with the communication unit, the key management facility of the second system sends a message which is encrypted with the encryption keys associated with the first system. In such a fashion, the communication unit is able to communicate on the second system. However, to provide for the communication unit to be able to communicate on the second system, the encryption key(s) of the first system must be disclosed to the second system. This means that the second system's key management facility therefore will have access to the first system's encryption key(s).

For many applications this is acceptable. For other applications, however, this presents an unacceptable breach of security. The second system's access to the first system's encryption key(s) permits a variety of unauthorized and undesired activities, including but not limited to eavesdropping, inappropriate programming of communication units, and so forth. Notwithstanding this attendant risk of compromised security, however, the above-described process, whereby a key management facility of a second system has knowing access to the encryption key(s) of another system in order to thereby effect the proper and timely rekeying of a communication unit that has roamed into the second system, essentially represents a typical and present best available rekeying process.

### BRIEF DESCRIPTION OF THE DRAWINGS

The above needs are at least partially met through provision of the encryption key rekeying apparatus and method described in the following detailed description, particularly when studied in conjunction with the drawings, wherein:

FIG. 1 comprises a block diagram of two communication systems as configured in accordance with an embodiment of the invention;

FIG. 2 comprises a block diagram of a portion of a key management facility as configured in accordance with an embodiment of the invention;

FIG. 3 comprises a flow diagram as configured in accordance with various embodiments of the invention;

FIG. 4 comprises a signaling diagram as configured in accordance with various embodiments of the invention.

FIG. 5 comprises a block diagram of two communication systems as configured in accordance with an alternative embodiment of the invention; and

FIG. 6 comprises a block diagram of two communication systems as configured in accordance with yet another alternative embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

In an exemplary approach, the first system key management facility communicates a roaming encryption key to a communication unit, wherein at least a portion of the roaming encryption key is encrypted using an encryption scheme that is decipherable by the communication unit. Further, the first system key management facility communicates the roaming encryption key to a second system key management facility, wherein at least a portion of the roaming encryption key is encrypted using an encryption scheme that is decipherable by the second system key management facility. Then, the second system key management facility utilizes the roaming encryption key to send a rekeying message to the communication unit where the communication unit has moved from the first system to the second system. So configured, the communication unit receives the rekeying message where the rekeying message is encrypted with the roaming encryption key. In one embodiment, the rekeying message has a visiting encryption key which is utilized for communications by the communication unit with the second system.

Because the communication unit utilizes a different encryption key for use on the second system then for use on the first system, access to the first system is not compromised. The second system key management facility neither has nor needs the encryption key that the first system key management facility employs to encrypt the communications on the first system. As a result, the encryption keys of the first system remain secure.

The rekeying message itself can comprise a single message or a plurality of messages as desired and/or as appropriate to the needs of a given system or protocol.

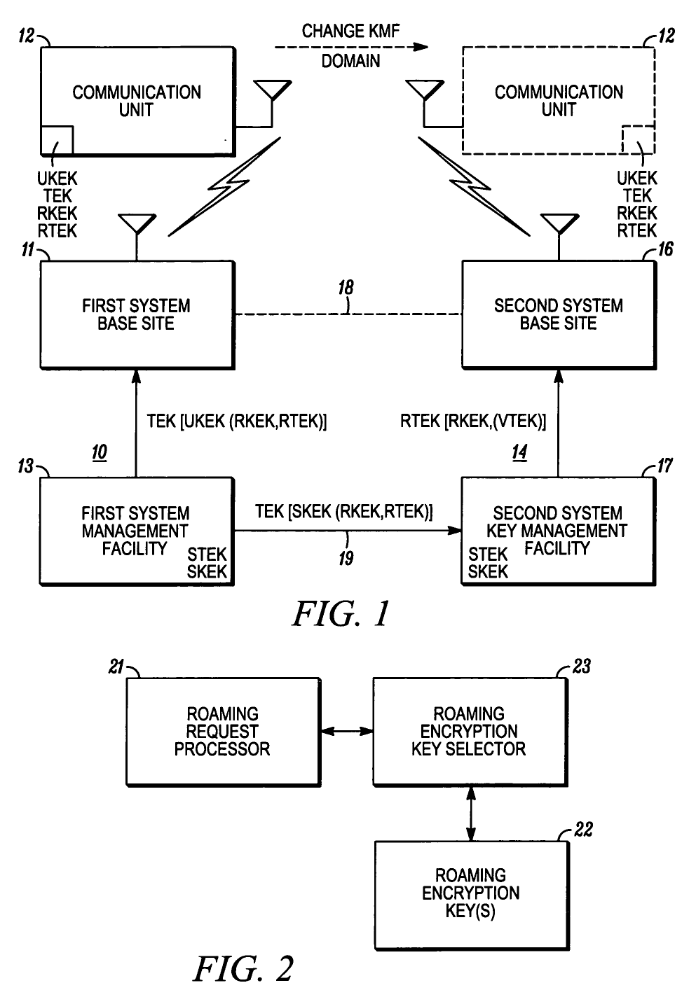

Referring now to the drawings, and in particular to FIG. 1, a first communication system 10 will typically include at least a first system base site 11 that supports wireless communications with one or (typically) more communication units 12 that operate within the coverage range of the first system base site 11. Those skilled in the art will recognize that, in a typical installation, a system such as this will more likely include a considerably greater number of base sites to permit expanded geographic coverage and/or expanded traffic capacity. Only one such base site is illustrated here for the purpose of fostering clarity. The communication services that this first system 10 supports can be many and can be varied (including, for example, both voice services and various kinds of bearer data services). The teachings set forth herein are compatible with such variations and will likely remain so as hereafter developed services are proposed or brought on-line. Such a system can also use whatever resource allocation and/or modulation and signaling protocol may be appropriate or desired to suit the needs of a given application. In general, such system elements are well understood in the art and therefore will not be elaborated on here in greater detail.

Encryption keys as utilized by the communication unit 12 are controlled by a first system key management facility 13 such as a key management facility as is known and understood in the art. As shown in FIG. 1, generally such a facility 13 operably couples to the first system base site 11; however, as is known in the art, more than one key management facility may be associated with one base site, e.g. base site 11. In any case, a key management facility, e.g. the first system key management facility 13, performs rekeying of communication units. Such rekeying can be occasioned in response to a variety of stimuli, including but not limited to specific requests from communication units or pre-programmed rekeying actions that are triggered by specific events or the attainment of a predetermined point in time. To this end, the first system key management facility 13 will typically have one or more encryption keys. The one or more encryption keys may be grouped into types of encryption keys such as one type for encrypting keys on the first system, one type for encrypting traffic on the first system, and one type for encrypting communications (whether those communications are other keys or traffic) on the second system. In an exemplary embodiment, an example key for encrypting keys on the first system is termed a unique key encryption key (UKEK), an example key for encrypting traffic on the first system is termed a traffic encryption key (TEK), an example key for encrypting keys on a second system is termed a roaming key encrypting key (RKEK), and an example key for encrypting traffic on a second system is termed a roaming traffic encryption key (RTEK).

For purposes of this description, the first system key management facility 13 uses the UKEK to encrypt keys on the first system. This means that keys within the first system 10 are encrypted as a function of UKEK. Further, the first system key management facility 13 presently uses the TEK to encrypt traffic on the first system. This means that traffic within the first system 10 is encrypted as a function of the TEK. Thus, to communicate the RKEK and RTEK to the first communication unit 12, first the RKEK and RTEK are encrypted with the UKEK to create an encrypted RKEK and RTEK, e.g. UKEK (RKEK, RTEK) as shown in FIG. 1. Then, the encrypted RKEK and RTEK is further encrypted with the TEK, e.g. TEK[UKEK(RKEK,RTEK)] as shown in FIG. 1, to create an encrypted message that can be sent over the air to the first communication unit.

With momentary reference to FIG. 2, the first system key management facility 13 will preferably include a roaming request processor 21, a roaming encryption key or keys 22, and a roaming encryption key selector 23. The below description is described with reference to usage of the term “roaming encryption key” but the term is meant to encompass more than one roaming encryption key. For example, in an exemplary embodiment, the roaming encryption key 22 encompasses the RKEK and RTEK described above. The roaming encryption key selector 23 serves, at least in part, to select a roaming encryption key (as a function, for example, of a temporal schedule). The selector 23 may select a roaming encryption key by generating it upon demand or by selecting one of many candidate keys. The roaming request processor 21 then serves, at least in part, to encrypt the roaming encryption key as selected by the encryption key selector 23 using another encryption key, e.g. as described above and termed the UKEK. It will be understood that the roaming encryption key can be essentially fixed for a given system or can be varied in response to the passage or time or the attainment or detection of other milestone events or triggers. It is also possible that the roaming encryption key can be the same as other encryption keys used in the first system if that approach is considered sufficiently secure for a given application.

Thus, the roaming request processor 21 provides the roaming encryption key to a communication unit by sending an encrypted message. This is achieved, in part, by encrypting the message containing the roaming encryption key by using another encryption key, e.g. as described above and termed the TEK. In an embodiment of the present invention, both the UKEK and TEK are possessed by the receiving communication unit so that the communication unit may decrypt the roaming encryption key. Furthermore, in an embodiment, the roaming encryption key will be encrypted using an encryption key that is likely not possessed by an intermediary communication system node (such as, but not limited to, an intermediary other-system key management facility).

Referring again to FIG. 1, as mentioned above, the communication unit 12 of the first system 10 can move away from the first system 10. For example, as illustrated, the communication unit 12 can move to a second system 14 having a second system base site 16 that supports wireless communications with one or (typically) more communication units 12 that operate within the coverage range of the second system base site 16. The communication unit 12 can communicate with other communication units (not shown) via the second system base site 16 and an appropriate link 18 that couples the latter to the first system 10 and ultimately to the first system base site 11. As with the first system 10, those skilled in the art will recognize that, in a typical installation, a system such as this will more likely include a considerably greater number of base sites to permit expanded geographic coverage and/or expanded traffic capacity. Only one such base site is illustrated here for the purpose of fostering clarity.

In this exemplary embodiment, the second system 14 has a second system key management facility 17. So configured, the second system key management facility 17 can administer the distribution and subsequent usage of an encryption key for use on the second system (which encryption key will typically be different from the encryption key used by the first system 10 and unknown to the latter as well). In an exemplary embodiment, the encryption key for use on the second system is termed a visiting traffic encryption key (VTEK). For the VTEK to be communicated to the communication unit, the first system communicates the roaming encryption key to the second system so that the second system may encrypt the communication containing the VTEK before it is sent wirelessly to the communication unit.

Further, the communication unit 12 of the first system 10 can switch key management facilities without changing base sites. For example, the communication unit 12 can switch from a first key management facility to a second key management facility where both are operably connected to the same base site. Thus, as mentioned above, more than one key management facility may be associated with one base site, e.g. base site 11. In any case, the communication unit 12 can move from being serviced by a first key management facility, e.g. 13, to being serviced by a second key management facility, e.g. 17. Whether the key management facilities are operably connected to one base site or more than one base site, the second system key management facility 17 can administer the distribution and subsequent usage of an encryption key for use on the second system key management facility 17 (which encryption key will typically be different from the encryption key used by the first system key management facility 13 and unknown to the latter as well).

Pursuant to an exemplary embodiment, the second system key management facility 17 has a communication link 19 to the first system key management facility 13 of the first system 10. As shown, this communication link 19 can comprise a dedicated link such as a landline. Other approaches can be used as well, however, including but not limited to a shared intranet or extranet (including, for example, the Internet) link. This link may be fully wireline, wireless, or a combination of both as may suit the needs and requirements of a given application. Further, as described below, the link may be created by manual means.

Pursuant to an exemplary embodiment, the first system key management facility 13 communicates the roaming encryption key to the second system key management facility 17 by utilizing encryption keys that are shared between the two facilities 13, 17. Example keys for encrypting communications between the two facilities 13, 17 include utilizing a shared key encryption key (SKEK) and a shared traffic encryption key (STEK). For example, for the first system key management facility 13 to communicate the roaming encryption key to the second system key management facility 17, the roaming encryption key is first encrypted using the SKEK to create an encrypted roaming encryption key (e.g. SKEK(RKEK,RTEK)). Then, the encrypted roaming encryption key is encrypted with the STEK to create an encrypted message (e.g. STEK [SKEK (RKEK, RTEK)]) that can be sent over the communication link 19. In such a manner, the second system key management facility 17 receives the roaming encryption key to rekey the communication unit that has moved form the first system to the second system.

In alternative embodiments, communications between the two facilities 13, 17 over the communication link 19 could use a public key protocol or any industry standard secure protocol, e.g. Secure Socket Layer (SSL), Internet Protocol Secure (IPSec), Secure Shell (SSH), etc. In yet further alternative embodiments, communications between the two facilities 13, 17 could be performed by a user of the first key management facility 13 manually copying information and loading it onto the second key management facility 17. For example, manually means to use a CD, a memory stick, Key Variable Loaders (KVL), etc. to perform the transfer of information. In yet further alternatives, though not recommended, the communications between the two facilities 13, 17 may be clear, e.g. not subject to secure means such as described above.

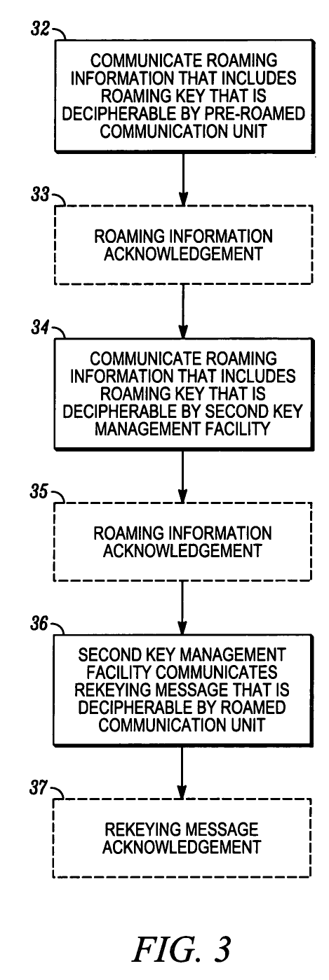

To illustrate an exemplary method of the present invention, and referring now to FIG. 3, the first system key management facility 13 can communicate 32 roaming information to the communication unit. In one embodiment, the roaming information includes roaming encryption keys, e.g. RKEK and RTEK, and wherein the roaming information is encrypted using an encryption scheme that is decipherable by the communication unit 12. The wireless facilities of the first system 10 are preferably employed to effect this communication. Optionally, the first system key management facility 13 will receive 33 an acknowledgement from the communication unit to confirm receipt of the roaming message.

Further, the first system key management facility 13 communicates 34 the roaming information to the second system key management facility via a message. In an exemplary embodiment the message comprising the roaming information is encrypted using a shared encryption key that is known to both the first system and the second system. That is, the second system does not require an intermediary platform to decrypt the message from the first system. Further, in an alternative embodiment, an intermediary communication system may function to forward this message comprising the roaming information from the first system key management facility 13 to the second system the key management facility 17. Optionally, the first system may receive 35 an acknowledgement in response to communicating the message.

Finally, the second system key management facility 17 communicates 36 a rekeying message to the communication unit wherein the rekeying message has information relating to the VTEK where the VTEK allows the communication unit to communicate within the second system securely and wherein the rekeying message is encrypted using the roaming information that was communicated by the first system key management facility 13 to the second system key management facility. Because the communication unit has been configured with the roaming information, the communication unit is able to decrypt the rekeying message upon receipt in the second system. There is no specific need for any encryption keys of the second system to be brought into usage.

Upon successfully receiving the rekeying message, if desired, the communication unit can transmit 37 a corresponding acknowledgement message that is then received by the second system key management facility 13. Of course, if such an acknowledgement is expected and not received, the key management facility can pursue such other course of action as may be desired or appropriate. For example, the key management facility can automatically retransmit the rekeying message. As another example, the key management facility can wait for a new rekeying request from the communication unit prior to taking any subsequent action.

The roaming message can comprise a single message or can be parsed over a plurality of discrete messages as desired. For example, the complete roaming message can include communicating a first roaming message to the communication unit and then providing a second roaming message to the communication unit (in response, for example, to receipt of an acknowledgement message from the communication unit in response to receiving the first roaming message).

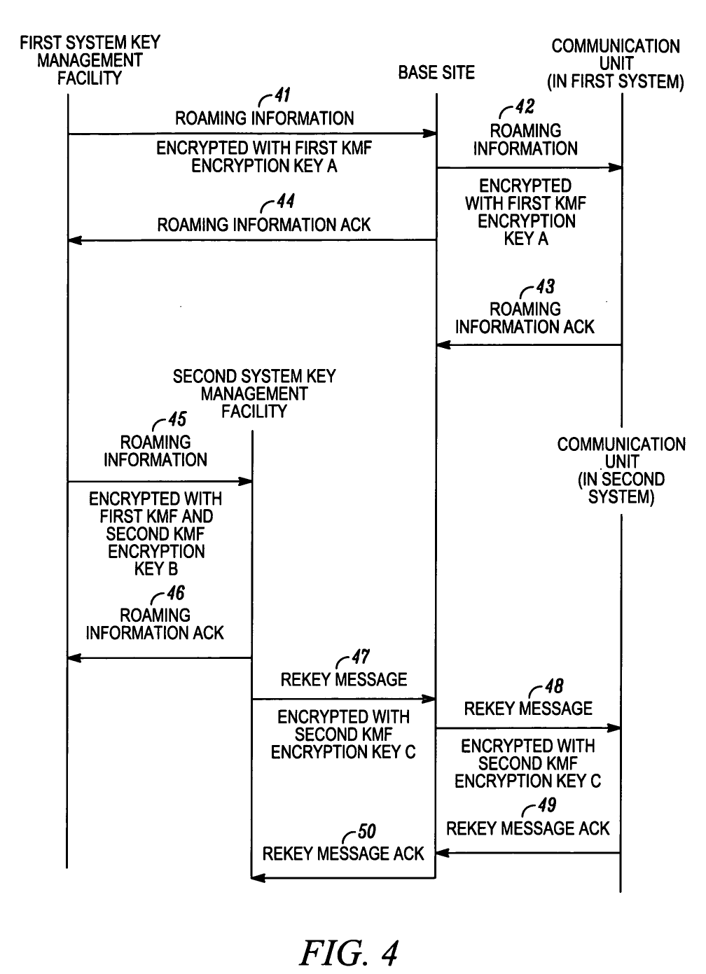

The overall flow of these various processes may be better understood upon reference to FIG. 4. A first system key management facility sends 41 roaming information to a base site which forwards 42 the roaming information to a communication unit. In response, the communication unit responds 43 with an acknowledgement which is forwarded 44 to the first system key management facility.

The first system key management facility also communicates 45 the roaming information to the second system key management facility where the communication is encrypted with a key that is known to the two facilities. In response, the second system key management facility acknowledges 46 the received information. Now that the second system key management facility has received the roaming information, the communication unit may communicate with the second system securely and without comprising the encryption keys which are specific to either the first or second system.

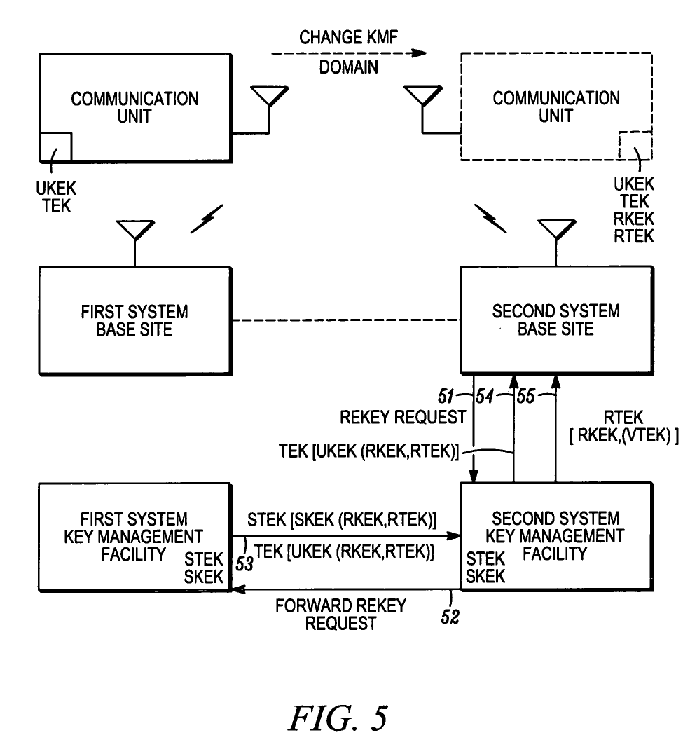

In one embodiment, for the communication system to communicate with the second system, the second system key management facility sends a rekeying message to the communication unit by first sending 47 a rekeying message to the base site serving the communication unit, e.g. a second system base site. The latter will then transmit 48 that encrypted rekey message to the communication unit. Following receipt of the rekey message, the communication unit transmits an acknowledgment 49 to the base site serving the communication unit, e.g. a second system base site, which forwards 50 that acknowledgement to the second system key management facility. As mentioned above, the same base site may serve both the first system key management facility and the second system key management facility. Thus, the base site in FIG. 4 may be one entity.

Where the communication unit may not be configured with the roaming information, namely the roaming encryption key(s), and the communication unit may already be within the second system, there are at least two alternative embodiments disclosed to provide the communication unit with the roaming information. In a first alternative and as illustrated in FIG. 5, the communication unit can send 51 a rekeying message to the second system key management facility. This rekey message will preferably be encrypted using, for example, a first encryption key for the first communication system. The second system key management facility functions as a proxy for rekeying messages with the first system key management facility. Namely, the second system key management facility forwards 52 the rekeying message to the first system key management facility. In response to the received rekeying message, the first system key management facility sends 53 the second system key management facility at least one message with the roaming information, e.g. the roaming encryption key(s). For example, the first system key management facility responds with the roaming information using a shared encryption key that is known to both systems. Further, the first system key management facility sends a response to the rekeying message to the second system key management facility which the second management facility forwards 54 to the communication unit. The rekeying message contains the roaming information, e.g. the roaming encryption key(s), which the communication unit utilizes to decode the communication 55 of the visiting traffic encryption key. This response to the rekey message will optionally include information regarding when the communication unit should begin to use the roaming information, e.g. the roaming encryption key. By designing the second system key management facility to serve as a proxy, the second system key management facility is not aware of the encryption keys that are specific to the communications between the first system key management facility and the communication unit. In such a fashion, the encryption keys used on the first system key management facility are maintained securely.

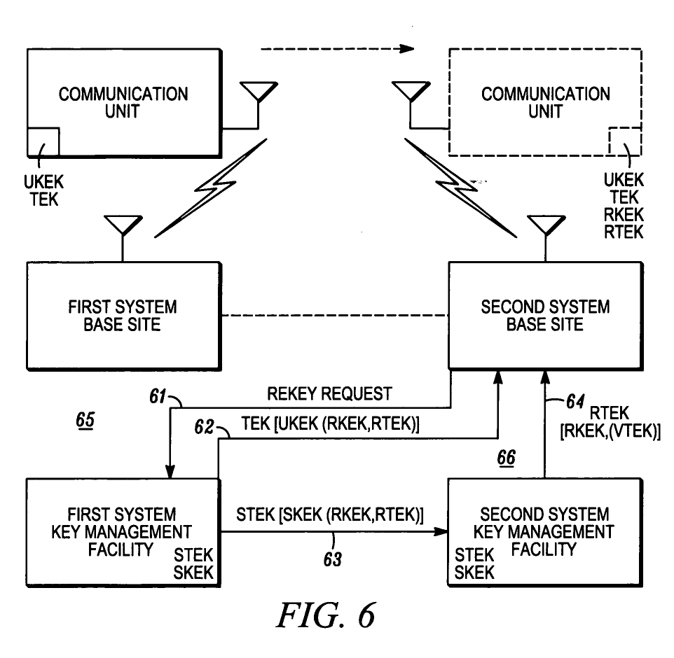

In a second alternative and as illustrated in FIG. 6, the communication unit can receive the roaming information from the first key management facility by sending a rekeying message to the second system base site where the second system base site directly communicates 61 the rekeying message to the first system key management facility. In response to the received rekeying message, the first system key management facility directly communicates 62 to the communication unit through the second system base site a message with the roaming information, e.g. the roaming encryption key. Preferably, this rekeying message sent by the first system key management facility is encrypted using, for example, a first encryption key for the first system. Thus, the first system 65 is communicating directly with the communication unit through the second system 66. As mentioned above, those skilled in the art will recognize that, in a typical installation, a system, such as either first system 65 or second system 66, will more likely include a considerably greater number of base sites to permit expanded geographic coverage and/or expanded traffic capacity. Only one base site for each system is illustrated here for the purpose of fostering clarity. Therefore, communicating directly as used herein means that the communication unit is able to receive the roaming information from the first system key management facility without communicating with the second system key management facility.

Further, the first system key management facility sends 63 a message comprising the roaming information, e.g. the roaming encryption key(s), to the second system key management facility by using a shared encryption key that is known to both the key management facilities. Further, both responses 62, 63 can optionally include information regarding when the roaming information, e.g. the roaming encryption key(s), is available for use. Once the second system key management facility knows of the roaming information, e.g. the roaming encryption key(s), it is able to use the roaming information to send 64 the communication unit a message with the visiting traffic encryption key that the communication unit may use for communications on the second system. Thus, by designing for direct communication between the communication unit and the first system key management facility, the second system key management facility is not aware of the encryption keys that are specific to the communications between the first system key management facility and the communication unit. In such a fashion, the encryption keys used on the first system key management facility are maintained securely.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a first system key management facility:
communicating to a communication unit roaming information, wherein at least a portion of the roaming information is encrypted using a first encryption scheme that is decipherable by the communication unit; and
communicating to a second system key management facility the roaming information, wherein at least a portion of the roaming information is encrypted as a function of a second encryption scheme that is decipherable by the second system key management facility.

2. The method of claim 1 wherein the roaming information comprises a roaming encryption key.

3. The method of claim 2 wherein the roaming encryption key is at least one of a roaming key encryption key and a roaming traffic key encryption key.

4. The method of claim 2 wherein the communication unit utilizes the roaming encryption key for rekeying with the second system key management facility.

5. The method of claim 1 wherein the first encryption scheme is at least one of a unique key encryption key and a traffic key encryption key.

6. The method of claim 1 further comprising:
at the second system key management facility:
communicating to the communicating unit a rekeying message wherein the rekeying message is encrypted with an encryption scheme associated with the roaming information.

7. The method of claim 6 wherein the rekeying message further comprises an encryption key for use with the second system key management facility.

8. The method of claim 1 wherein the step of communicating to a communication unit roaming information further comprises the step of communicating at least one of a) wirelessly and b) via a wired connection to the first system key management facility.

9. The method of claim 1 further comprising the step of acknowledging in response the steps of communicating.

10. The method of claim 1 wherein the second encryption scheme is at least one of a shared key encryption key, a shared traffic key encryption key, public key protocol, an industry standard secure protocol, and manual means.

11. The method of claim 1 further comprising:
at the second system key management facility:
receiving a rekey request from a communication unit within coverage of the second system key management facility;
forwarding the rekey request to the first system key management facility;
receiving the roaming information from the first system key management facility, wherein at least a portion of the roaming information is encrypted as a function of a second encryption scheme that is decipherable by the second system key management facility;
forwarding a response from the first system key management facility wherein the response comprises roaming information for the communication unit; and
communicating to the communication unit a rekeying message wherein the rekeying message is encrypted with an encryption scheme associated with the roaming information.

12. The method of claim 11 further comprising receiving an acknowledgement message from the communication unit to indicate successful reception of the roaming information.

13. The method of claim 11 wherein the second encryption scheme is at least one of a shared key encryption key and a shared traffic encryption key.

14. A method for rekeying communication units, comprising:
at a communication unit, wherein the communication unit is in communication with a second key management facility:
receiving a message comprising an encrypted key for use with the second system key management facility wherein at least a portion of the message is encrypted using a roaming encryption key that is decipherable by the communication unit,
wherein the roaming encryption key is for rekeying with the second system key management facility.

15. The method of claim 14 wherein the roaming encryption key is at least one of a roaming key encryption key and a roaming traffic key encryption key.

16. The method of claim 14 wherein the encrypted key is a visiting traffic encryption key.

17. The method of claim 14 further comprising the steps of:
receiving the roaming encryption key from a first system key management facility before receiving the message,
wherein the first system key management facility sends the roaming encryption key to the communication unit.

18. The method of claim 17 wherein the first system key management facility sends the roaming encryption key in at least one of four ways comprising a) directly to the communication unit, b) over the air to the communication unit, c) via a second system key management facility where the second system key management facility serves as a proxy for forwarding to the communication unit, and d) via a second system base site where the second system base site communicates directly with the first system key management facility.

19. The method of claim 17 further comprising the step of sending a rekey request to the second system key management facility requesting the roaming encryption key before receiving the message.

20. A key management facility comprising:
at least one roaming encryption key;
a roaming encryption key selector comprising a roaming encryption key output;
a roaming request processor that is operably coupled to the roaming encryption key selector;
a wireless communication interface that is operably coupled to the at least one roaming encryption key and the roaming encryption request processor; and
wherein the wireless communication interface further couples to a wireless communications system that supports wireless encrypted communications amongst authorized communication units using the at least one roaming encryption key.
